(19) United States
(12) Patent Application Publication
(10) Pub. No.: US 2025/0322281 A1
(43) Pub. Date: Oct. 16, 2025

(54) NON-RECIPROCAL CIRCUIT ELEMENT AND QUANTUM COMPUTER

(71) Applicant: TDK CORPORATION, Tokyo (JP)

(72) Inventors: Yoshiaki SATO, Tokyo (JP); Takekazu YAMANE, Tokyo (JP); Hidenori OHATA, Tokyo (JP)

(73) Assignee: TDK CORPORATION, Tokyo (JP)

(21) Appl. No.: 19/175,762

(22) Filed: Apr. 10, 2025

(30) Foreign Application Priority Data
Apr. 11, 2024 (JP) 2024-063720

(51) Int. Cl. G06N 10/40; H01P 1/36; H01P 1/38

(52) U.S. Cl. CPC G06N 10/40; H01P 1/36; H01P 1/38

(57) ABSTRACT

According to the present invention, a non-reciprocal circuit element includes a conductor, a magnetic body, an absorber, and a resonator. The absorber and the magnetic body are located at different positions when viewed in a thickness direction. The conductor has a first terminal and a second terminal. The conductor has a first region extending between the first terminal and the second terminal and a second region different from the first region. The first region overlaps the magnetic body when viewed in the thickness direction. The second region overlaps the absorber when viewed in the thickness direction. The resonator overlaps the absorber when viewed in the thickness direction.

### BACKGROUND OF THE INVENTION

### Field of the Invention

The present disclosure relates to a non-reciprocal circuit element and a quantum computer.

Priority is claimed on Japanese Patent Application No. 2024-063720, filed Apr. 11, 2024, the content of which is incorporated herein by reference.

### Description of Related Art

A non-reciprocal circuit element is an element that specifies a transmission direction of a high-frequency signal. Isolators and circulators are examples of non-reciprocal circuit elements. Non-reciprocal circuit elements are widely used in circuits that transmit high-frequency signals.

Non-reciprocal circuit elements are used in various places where high-frequency signals are used. For example, Patent Document 1 discloses an isolator for microwave communication. For example, Patent Document 2 describes the use of an isolator in a quantum computer.

### PATENT DOCUMENTS

[Patent Document 1] Japanese Unexamined Patent Application, First Publication No. H4-287403
[Patent Document 2] Japanese Patent No. 6998459

### SUMMARY OF THE INVENTION

A non-reciprocal circuit element is arranged on a signal line connected to a quantum processor that controls a quantum computer. The quantum processor is arranged in a freezing chamber and a volume of the freezing chamber is limited. For this reason, a small non-reciprocal circuit element is required. Moreover, one of the characteristics required for a non-reciprocal circuit element is an isolation characteristic. There is a demand for a non-reciprocal circuit element having an excellent isolation characteristic for a high-frequency signal in an available band.

The present disclosure has been made in consideration of the above circumstances and an objective of the present disclosure is to provide a non-reciprocal circuit element capable of designing an isolation characteristic.

The present disclosure provides the following means to solve the above problem.

According to the present embodiment, a non-reciprocal circuit element includes a conductor, a magnetic body, an absorber, and a resonator. The absorber and the magnetic body are located at different positions when viewed in a thickness direction. The conductor has a first terminal and a second terminal. The conductor has a first region extending between the first terminal and the second terminal and a second region different from the first region. The first region overlaps the magnetic body when viewed in the thickness direction. The second region overlaps the absorber when viewed in the thickness direction. The resonator overlaps the absorber when viewed in the thickness direction.

The non-reciprocal circuit element according to the present disclosure can design an isolation characteristic.

### BRIEF DESCRIPTION OF THE DRAWINGS

FIG. 1 is a cross-sectional view of a non-reciprocal circuit element according to a first embodiment.

FIG. 2 is an expanded plan view of the non-reciprocal circuit element according to the first embodiment.

FIG. 3 is a plan view of a conductor and a resonator of a non-reciprocal circuit board according to the first embodiment.

FIG. 4 is a plan view of a loss layer of the non-reciprocal circuit board according to the first embodiment.

FIG. 5 is a plan view of a grounding body and a magnet of the non-reciprocal circuit board according to the first embodiment.

FIG. 6 is a schematic diagram of a quantum computer according to the first embodiment.

FIG. 7 is an expanded plan view of a non-reciprocal circuit element according to a second embodiment.

FIG. 8 is an expanded plan view of a non-reciprocal circuit element according to a third embodiment.

FIG. 9 is an expanded plan view of a non-reciprocal circuit element according to a fourth embodiment.

FIG. 10 is an expanded plan view of a non-reciprocal circuit element according to a fifth embodiment.

FIG. 11 is an expanded plan view of a non-reciprocal circuit element according to a sixth embodiment.

FIG. 12 is an expanded plan view of a non-reciprocal circuit element according to a seventh embodiment.

FIG. 13 is an expanded plan view of a non-reciprocal circuit element according to an eighth embodiment.

FIG. 14 is a cross-sectional view of a non-reciprocal circuit element according to a first modified example.

FIG. 15 shows measurement results of isolation characteristics of the non-reciprocal circuit elements according to Inventive Example 1, Inventive Example 2, and Comparative Example 1.

FIG. 16 shows measurement results of reflection loss characteristics of the non-reciprocal circuit elements according to Inventive Example 1, Inventive Example 2, and Comparative Example 1.

FIG. 17 shows measurement results of insertion loss characteristics of the non-reciprocal circuit elements according to Inventive Example 1, Inventive Example 2, and Comparative Example 1.

### DETAILED DESCRIPTION OF THE INVENTION

Hereinafter, the present embodiment will be described in detail with reference to the drawings as appropriate. In the drawings used in the following description, featured parts may be enlarged for convenience so that features are easier to understand, and dimensional ratios and the like of the respective constituent elements may be different from actual ones. Materials, dimensions, and the like exemplified in the following description are examples, the present disclosure is not limited thereto, and modifications can be appropriately made in a range in which advantageous effects of the present disclosure are exhibited.

First, directions are defined. One direction of a surface on which a conductor extends is defined as an x-direction. For example, a direction in which a first terminal T1 and a second terminal T2 of the conductor are connected is defined as the x-direction. Moreover, a direction perpendicular to the x-direction on the surface on which the conductor extends is defined as a y-direction. A direction perpendicular to the x-direction and the y-direction is defined as a z-direction. A thickness direction of each layer is an example of the z-direction.

### First Embodiment

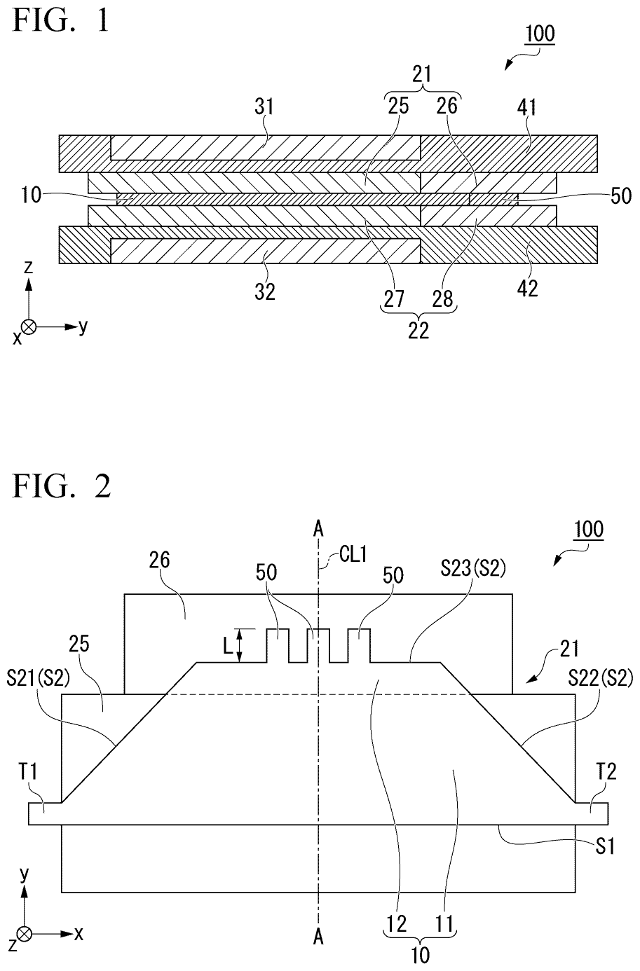

FIG. 1 is a cross-sectional view of a non-reciprocal circuit element 100 according to a first embodiment. The non-reciprocal circuit element 100 includes, for example, a conductor 10, a first loss layer 21, a second loss layer 22, a first magnet 31, a second magnet 32, a first grounding body 41, a second grounding body 42, and a resonator 50. The non-reciprocal circuit element 100, for example, functions as an isolator.

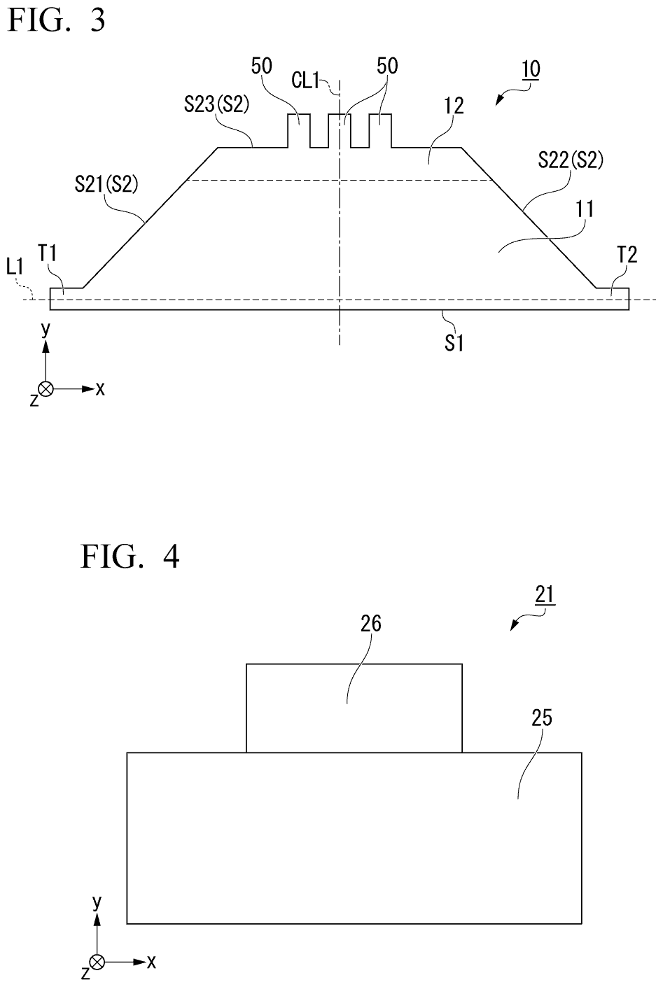

FIG. 2 is an expanded plan view of the non-reciprocal circuit element 100 according to the first embodiment. FIG. 1 is a cross-sectional view taken along line A-A in FIG. 2. FIG. 2 is a plan view of the first loss layer 21 from the conductor 10 side in a state in which the second loss layer 22, the second magnet 32, and the second grounding body 42 are excluded from the non-reciprocal circuit element 100. FIG. 3 is a plan view of the conductor 10 and the resonator 50 of the non-reciprocal circuit element 100 according to the first embodiment. FIG. 4 is a plan view of the first loss layer 21 of the non-reciprocal circuit element 100 according to the first embodiment.

The conductor 10 has the first terminal T1 and the second terminal T2. The first terminal T1 and the second terminal T2 are connected to external terminals.

The conductor 10 transmits a high-frequency signal. The conductor 10 non-reciprocally transmits a high-frequency signal between the first terminal T1 and the second terminal T2. “Non-reciprocally transmitting the high-frequency signal” indicates that the propagation efficiency of the signal differs according to the direction. For example, when the signal propagates with low loss in a forward direction but hardly propagates in a reverse direction, this corresponds to “non-reciprocally transmitting the high-frequency signal.” The propagation direction of the high-frequency signal in the conductor 10 is controlled by the first loss layer 21 and the second loss layer 22 to be described below.

The high-frequency signal input from the first terminal T1 is transmitted to the second terminal T2 with low loss. Most of the high-frequency signal input from the second terminal T2 is absorbed. In other words, substantially no high-frequency signal is transmitted from the second terminal T2 to the first terminal T1. In other words, the high-frequency signal is transmitted with low loss from the first terminal T1 to the second terminal T2, but substantially no signal is transmitted from the second terminal T2 to the first terminal T1.

There is no particular restriction on the conductor 10 as long as it transmits high-frequency signals with high efficiency. The conductor 10 is, for example, aluminum, copper, silver, gold, stainless steel, or the like. The conductor 10 may be a non-conductor or a conductor with a high resistance value (e.g., phosphor bronze) plated with aluminum, copper, silver, gold, stainless steel, or the like.

The conductor 10 has a first region 11 and a second region 12. The conductor 10 may have regions other than the first region 11 and the second region 12. The first region 11 is a region that overlaps the first magnetic body 25 in the z-direction. The first region 11 extends across the first terminal T1 and the second terminal T2. The first region 11 is sandwiched between the first magnetic body 25 and the second magnetic body 27 in the z-direction. The second region 12 is a region that overlaps the first absorber 26 in the z-direction. The second region 12 is sandwiched between the first absorber 26 and the second absorber 28 in the z-direction. A boundary between the first region 11 and the second region 12 coincides with a boundary between the first magnetic body 25 and the first absorber 26, for example, when viewed in the z-direction.

The conductor 10 has a first connection line S1 and a second connection line S2 on its outer periphery when viewed in the z-direction. The first connection line S1 and the second connection line S2 are lines that connect the first terminal T1 and the second terminal T2, respectively. The first connection line S1 and the second connection line S2 join together to form the outer periphery of the conductor 10 when viewed in the z-direction.

The first connection line S1 is one side of the first region 11. The first connection line S1 may be a straight line or a curved line. In the example shown in FIG. 3, the first connection line S1 is a straight line parallel to a straight line L1 that connects the first terminal T1 and the second terminal T2.

The second connection line S2 is located across the first region 11 and the second region 12. The second connection line S2 has, for example, a first side S21 and a second side S22 extending from the first region 11 to the second region 12, and a third side S23 that is one side of the second region 12. The first side S21, the second side S22, and the third side S23 may be straight or curved.

The resonator 50 confines a high-frequency signal within a certain space. The resonator 50 confines a part of the high-frequency signal propagating along the second connection line S2. The resonator 50 is within a range of the high-frequency signal propagating along the second connection line S2. The resonator 50 is connected to, for example, the conductor 10. The resonator 50 and the conductor 10 may be integrated. The resonator 50 has, for example, one or more protrusions protruding from the third side S23. A connection part between the protrusion and the conductor 10 becomes a free end of the high-frequency signal, one side of the protrusion becomes a fixed end of the high-frequency signal, and the high-frequency signal is confined within the resonator 50.

The resonator 50 shown in FIGS. 2 and 3 is a quarter-wavelength resonator. The quarter-wavelength resonator satisfies a relationship of L≤¼f₀(ε₀μ₀ε_{γ}μ_{γ})^{1/2} . . . (1). L denotes a length of the quarter-wavelength resonator, f₀ denotes a resonant frequency, ¿₀ denotes vacuum permittivity, μ₀ denotes vacuum magnetic permeability, ¿_{γ} denotes permittivity of the absorber, and μ_{γ} denotes magnetic permeability of the absorber. When the length L of the resonator 50 is an integer multiple of the quarter-wavelength of the high-frequency signal propagating along the second connection line S2, the resonator 50 confines the high-frequency signal. The length L is a length in a protruding direction from the third side S23 of the resonator 50.

The resonator 50 overlaps the first absorber 26 when viewed in the z-direction. The resonator 50 is sandwiched between the first absorber 26 and the second absorber 28 in the z-direction.

The resonator 50 is made of a conductor. For example, a material similar to that of the conductor 10 can be used for the resonator 50.

The resonator 50 shown in FIGS. 2 and 3, for example, is symmetrical with respect to a center line CL1 in the x-direction. The center line CL1 is a line that passes through the center of the straight line connecting the first terminal T1 and the second terminal T2 and is perpendicular to the straight line. It is easy to form the resonator 50 symmetrical with respect to the center line CL1. The resonator 50 symmetrical with respect to the center line CL1 is highly versatile.

The first loss layer 21 and the second loss layer 22 sandwich the conductor 10 and the resonator 50 in the z-direction. The first loss layer 21 includes a first magnetic body 25 and a first absorber 26. The second loss layer 22 includes a second magnetic body 27 and a second absorber 28. The first loss layer 21 and the second loss layer 22 have substantially the same shape and are symmetrical while sandwiching the conductor 10 and the resonator 50. The first loss layer 21 is located between the conductor 10 and the first magnet 31. The second loss layer 22 is located between the conductor 10 and the second magnet 32.

The first magnetic body 25 and the first absorber 26 are located at different positions in an xy plane when viewed in the z-direction. The second magnetic body 27 and the second absorber 28, for example, are located at different positions in the xy plane when viewed in the z-direction. The first magnetic body 25 and the second magnetic body 27 are located at a position overlapping the first region 11 of the conductor 10 in the z-direction. The first magnetic body 25 and the second magnetic body 27 sandwich the first region 11 in the z-direction. The first absorber 26 and the second absorber 28 are located at a position overlapping the second region 12 of the conductor 10 and the resonator 50 in the z-direction. The first absorber 26 and the second absorber 28 sandwich the second region 12 and the resonator 50 in the z-direction.

The first magnetic body 25 and the second magnetic body 27 may have any shape as long as they can cover the first region 11. The first absorber 26 and the second absorber 28 may have any shape as long as they can cover the second region 12 and the resonator 50. For example, as shown in FIG. 4, both the first magnetic body 25 and the first absorber 26 may have a rectangular shape when viewed in the z-direction.

When a direct current (DC) magnetic field is applied to the first magnetic body 25 and the second magnetic body 27, a high-frequency signal passing through the conductor 10 propagates while deflecting to one side of a traveling direction. For example, a high-frequency signal input from the first terminal T1 is deflected in the vicinity of the first connection line S1 and propagates to the second terminal T2 along the first connection line S1. On the other hand, a high-frequency signal input to the second terminal T2 is deflected in the vicinity of the second connection line S2 and propagates to the first terminal T1 along the second connection line S2. At this time, a high-frequency signal input to the second terminal T2 is absorbed by the first absorber 26 and the second absorber 28 and is greatly attenuated. Moreover, the high-frequency signal input to the second terminal T2 is trapped by the resonator 50 and the strength of the high-frequency signal trapped by the resonator 50 is greatly attenuated.

The first magnetic body 25 and the second magnetic body 27 include a magnetic material. The first magnetic body 25 and the second magnetic body 27 may be a conductor or an insulator. The first magnetic body 25 and the second magnetic body 27 include, for example, a soft magnetic body. The first magnetic body 25 and the second magnetic body 27 include, for example, any one selected from the group consisting of Co-based amorphous, ferrite, Fe₈₅Si₂B₈P₄Cu, Fe₈₆AlB₈P₄Cu, Fe₇₈Si₉B₁₃, and yttrium iron garnet (YIG). YIG is, for example, Y₃Fe₂(FeO₄)₃ or Y₃Fe₅O₁₂.

The first magnetic body 25 and the second magnetic body 27 may be a mixture of magnetic particles and resin. The magnetic particles may include, for example, iron, silicon steel (Fe—Si), permalloy (Ni—Fe), permendur (Fe—Co), sendust (Fe—Si—Al), electromagnetic stainless steel, amorphous iron-based alloys (an Fe—B—C-based alloy and an Fe—Co-based alloy), manganese zinc ferrite, nickel zinc ferrite, and the like. The first magnetic body 25 and the second magnetic body 27 may be a mixture of ferrite particles and resin.

When a magnetic material is dispersed in an insulation material (for example, resin, rubber, paint, or the like), a volume ratio of the magnetic material is preferably 10% or more and 70% or less. If the volume ratio of the magnetic material is low, the electromagnetic wave absorption capacity will be small. If the volume ratio of the magnetic material is high, it will be difficult to disperse the magnetic material in the insulation material.

The first absorber 26 and the second absorber 28 include a material having a larger magnetic field loss rate than the first magnetic body 25 and the second magnetic body 27. The first absorber 26 and the second absorber 28 include, for example, any one selected from the group consisting of iron, BN, conductive carbon, SiC, and Ni-based ferrite.

When the first loss layer 21 and the second loss layer 22 are conductors, an insulation layer is provided between the first loss layer 21 and the conductor 10 and between the second loss layer 22 and the conductor 10. A publicly known insulation layer can be used.

The first magnet 31 and the second magnet 32 sandwich the conductor 10, the first loss layer 21, and the second loss layer 22 in the z-direction. The first magnet 31 and the conductor 10 sandwich the first loss layer 21 in the z-direction. The second magnet 32 and the conductor 10 sandwich the second loss layer 22 in the z-direction. The first magnet 31 and the second magnet 32 apply a DC magnetic field to the first magnetic body 25 and the second magnetic body 27.

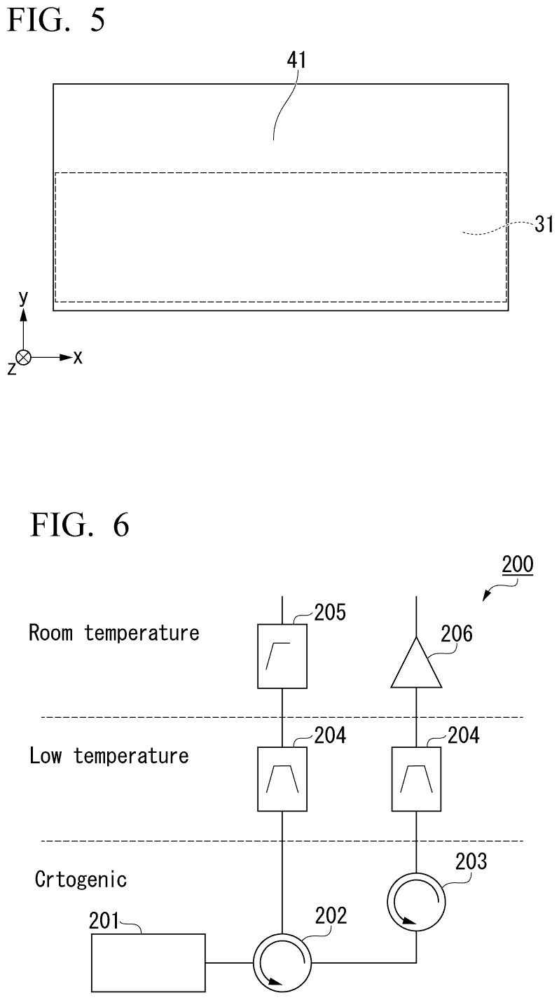

FIG. 5 is a plan view of the first magnet 31 and the first grounding body 41 of the non-reciprocal circuit element 100 according to the first embodiment. The first magnet 31 and the second magnet 32 are positioned to overlap the first magnetic body 25 and the second magnetic body 27 when viewed in the z-direction. Parts of the first magnet 31 and the second magnet 32 may overlap the first absorber 26 and the second absorber 28 when viewed in the z-direction.

The first magnet 31 and the second magnet 32 are, for example, hard magnetic bodies. The first magnet 31 and the second magnet 32 may be insulators or conductors. The first magnet 31 and the second magnet 32 include, for example, any one selected from the group consisting of an insulating ferrite magnet, a conductive rare earth magnet, TbFeCo, GdFeCo, SmFeCo, a [Co/Pt] multilayer film, and a [Co/Pd] multilayer film. If the first magnet 31 and the second magnet 32 are conductors, the first grounding body 41 and the second grounding body 42 may be omitted.

The first magnet 31 and the second magnet 32 are an example of a magnetic field source. The magnetic field source is not limited to the first magnet 31 and the second magnet 32 as long as it can apply a DC magnetic field to the first magnetic body 25 and the second magnetic body 27.

The first grounding body 41 is sandwiched between the first magnet 31 and the first loss layer 21. The second grounding body 42 is sandwiched between the second magnet 32 and the second loss layer 22. The first grounding body 41 or the second grounding body 42 is grounded to, for example, a reference potential. The reference potential is, for example, the ground. The first grounding body 41 and the second grounding body 42 do not particularly matter as long as they have conductivity.

The non-reciprocal circuit element 100 according to the present embodiment has an excellent isolation characteristic because it has the resonator 50. The resonator 50 confines a part of the high-frequency signal input from the second terminal T2 within the resonator 50, and prevents the high-frequency signal input from the second terminal T2 from reaching the first terminal T1. The smaller the strength of the high-frequency signal reaching the first terminal T1 from the second terminal T2, the better the isolation characteristic of the non-reciprocal circuit element 100.

The non-reciprocal circuit element 100 according to the present embodiment can be applied to, for example, a quantum computer. FIG. 6 is a schematic diagram of the quantum computer according to the present embodiment. The quantum computer 200 includes, for example, a quantum processor 201, non-reciprocal circuit elements 202 and 203, filters 204 and 205, and an amplifier 206.

The quantum processor 201 performs quantum calculations. The non-reciprocal circuit elements 202 and 203 distribute a read signal of a quantum bit from the quantum processor 201. The non-reciprocal circuit element 202 is a circulator. The non-reciprocal circuit element 203 is an isolator. The non-reciprocal circuit element 100 according to the present embodiment can be applied to the non-reciprocal circuit element 203. The amplifier 206 amplifies the read signal.

For example, a superconducting quantum computer operates at extremely low temperatures. Therefore, the quantum processor 201 and the non-reciprocal circuit elements 202 and 203 are also arranged at positions exposed to an extremely low-temperature environment. It is difficult to maintain a large volume of space in an extremely low-temperature environment, and miniaturization of the non-reciprocal circuit elements 202 and 203 is required. Because the non-reciprocal circuit element 100 according to the present embodiment is small and has excellent isolation characteristics, it is suitable for application to quantum computers.

### Second Embodiment

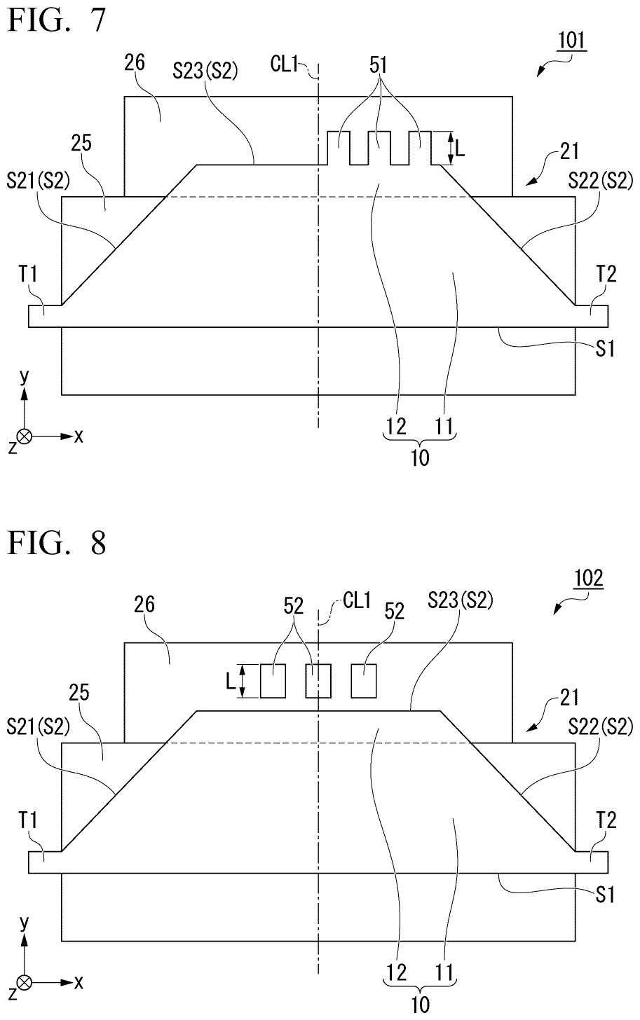

FIG. 7 is an expanded plan view of the non-reciprocal circuit element 101 according to a second embodiment. The non-reciprocal circuit element 101 includes a conductor 10, a first loss layer 21, a second loss layer 22, a first magnet 31, a second magnet 32, a first grounding body 41, a second grounding body 42, and a resonator 51. In the non-reciprocal circuit element 101, constituent elements similar to those in the non-reciprocal circuit element 100 are denoted by similar reference signs and description thereof will be omitted.

Unlike the resonator 50 in the first embodiment, the resonator 51 is asymmetrical with respect to a center line CL1 in the x-direction. The other configurations of the resonator 51 are similar to those of the resonator 50.

The resonator 51 is a quarter-wavelength resonator. A position of the resonator 51 is not important as long as it is asymmetrical with respect to the center line CL1 in the x-direction. For example, the resonator 51 may be located on a first terminal T1 side of the center line CL1 or may be located on both the first terminal T1 side and a second terminal T2 sides with respect to the center line CL1. The strength of a high-frequency signal input from the second terminal T2 becomes weaker as it approaches the first terminal T1. Therefore, if the resonator 51 is located on the second terminal T2 side where the strength of the high-frequency signal is strong, the isolation characteristics are further improved.

The non-reciprocal circuit element 101 according to the second embodiment has the resonator 51, and therefore has an effect similar to that of the non-reciprocal circuit element 100. The non-reciprocal circuit element 101 according to the second embodiment can be applied to a quantum computer, like the non-reciprocal circuit element 100.

### Third Embodiment

FIG. 8 is an expanded plan view of a non-reciprocal circuit element 102 according to a third embodiment. The non-reciprocal circuit element 102 includes a conductor 10, a first loss layer 21, a second loss layer 22, a first magnet 31, a second magnet 32, a first grounding body 41, a second grounding body 42, and a resonator 52. In the non-reciprocal circuit element 102, constituent elements similar to those in the non-reciprocal circuit element 100 are denoted by similar reference signs and description thereof will be omitted.

Unlike the resonator 50 in the first embodiment, the resonator 52 is not connected to the conductor 10. The other configurations of the resonator 52 are similar to those of the resonator 50.

The resonator 52 is a half-wavelength resonator with both ends open. The shape of the resonator 52 in plan view is, for example, rectangular. Both ends of the resonator 52 are fixed ends and the resonator 52 confines a high-frequency signal when a length L of the resonator 52 is an integer multiple of ½ of a wavelength of a high frequency propagating along a second connection line S2. Even if the resonator 52 and the conductor 10 are not electrically connected, electromagnetic waves of the high-frequency signal reach the resonator 52.

The non-reciprocal circuit element 102 according to the third embodiment has the resonator 52, and therefore has an effect similar to that of the non-reciprocal circuit element 100. Moreover, because the resonator 52 is not connected to the conductor 10, there is a high degree of freedom in layout and shape. The non-reciprocal circuit element 102 according to the third embodiment can be applied to a quantum computer, like the non-reciprocal circuit element 100.

### Fourth Embodiment

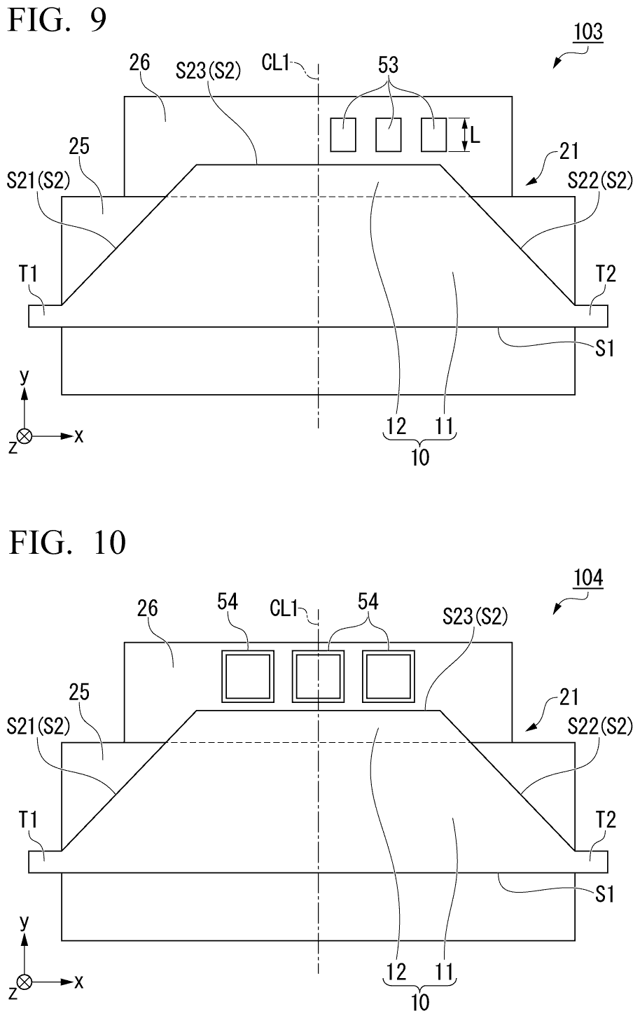

FIG. 9 is an exploded plan view of a non-reciprocal circuit element 103 according to a fourth embodiment. The non-reciprocal circuit element 103 includes a conductor 10, a first loss layer 21, a second loss layer 22, a first magnet 31, a second magnet 32, a first grounding body 41, a second grounding body 42, and a resonator 53. In the non-reciprocal circuit element 103, constituent elements similar to those in the non-reciprocal circuit element 100 are denoted by similar reference signs and description thereof will be omitted.

Unlike the resonator 52 in the third embodiment, the resonator 53 is asymmetrical with respect to a center line CL1 in the x-direction. The other configurations of the resonator 53 are similar to those of the resonator 52. Unlike the resonator 51 in the second embodiment, the resonator 53 is not connected to the conductor 10. The resonator 53 is a half-wavelength resonator with both ends open.

The non-reciprocal circuit element 103 according to the fourth embodiment has the resonator 53, and therefore has an effect similar to that of the non-reciprocal circuit element 100. Moreover, because the resonator 53 is not connected to the conductor 10, there is a high degree of freedom in layout and shape. Moreover, the isolation characteristics can be further improved by arranging the resonator 53 on the second terminal T2 side where the strength of the high-frequency signal is strong. The non-reciprocal circuit element 103 according to the fourth embodiment can be applied to a quantum computer, like the non-reciprocal circuit element 100.

### Fifth Embodiment

FIG. 10 is an expanded plan view of a non-reciprocal circuit element 104 according to a fifth embodiment. The non-reciprocal circuit element 104 includes a conductor 10, a first loss layer 21, a second loss layer 22, a first magnet 31, a second magnet 32, a first grounding body 41, a second grounding body 42, and a resonator 54. In the non-reciprocal circuit element 104, constituent elements similar to those in the non-reciprocal circuit element 100 are denoted by similar reference signs and description thereof will be omitted.

The resonator 54 is a ring resonator. A high-frequency signal propagating along a second connection line S2 is coupled with the ring resonator and trapped by the ring resonator. The resonator 54 is within a range of the high-frequency signal propagating along the second connection line S2. The resonator 54, for example, is not connected to the conductor 10. The resonator 54 is a ring-shaped conductor. The resonator 54 is sandwiched between the first absorber 26 and the second absorber 28 in the z-direction. The resonator 54 may be symmetrical or asymmetrical with respect to a center line CL1 in the x-direction.

The non-reciprocal circuit element 104 according to the fifth embodiment has the resonator 54, and therefore has an effect similar to that of the non-reciprocal circuit element 100. The non-reciprocal circuit element 104 according to the fifth embodiment can be applied to a quantum computer like the non-reciprocal circuit element 100.

### Sixth Embodiment

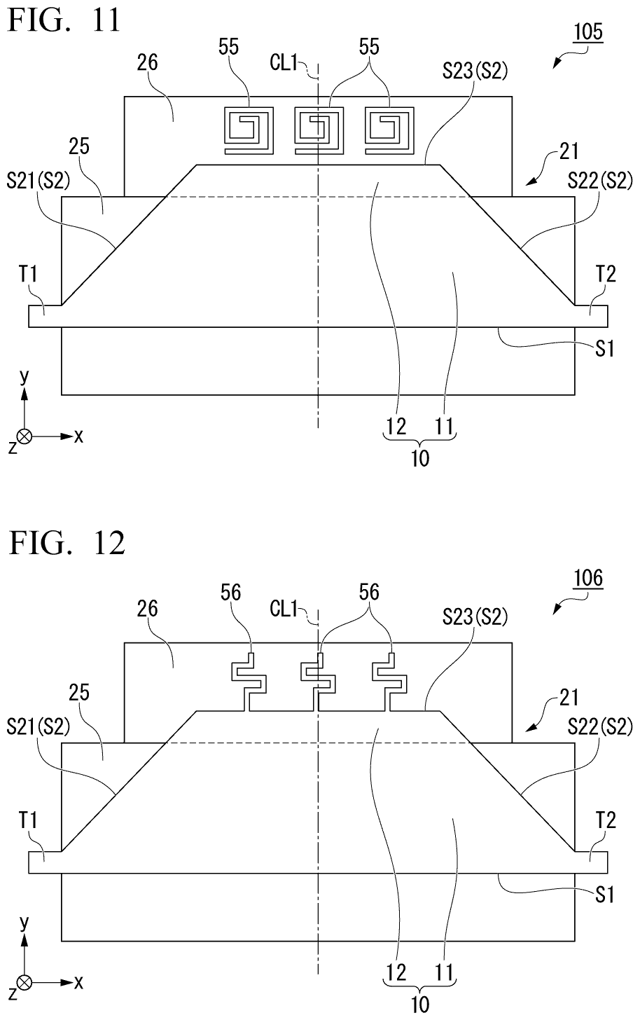

FIG. 11 is an exploded plan view of a non-reciprocal circuit element 105 according to a sixth embodiment. The non-reciprocal circuit element 105 includes a conductor 10, a first loss layer 21, a second loss layer 22, a first magnet 31, a second magnet 32, a first grounding body 41, a second grounding body 42, and a resonator 55. In the non-reciprocal circuit element 105, constituent elements similar to those in the non-reciprocal circuit element 100 are denoted by similar reference signs and description thereof will be omitted.

The resonator 55 is a spiral resonator. A high-frequency signal propagating along a second connection line S2 is coupled with the spiral resonator and trapped by the spiral resonator. The resonator 55 is within a range of the high-frequency signal propagating along a second connection line S2. The resonator 55, for example, is not connected to the conductor 10. The resonator 55 is a conductor processed into a spiral shape. The resonator 55 is sandwiched between the first absorber 26 and the second absorber 28 in the z-direction. The resonator 55 may be symmetrical or asymmetrical with respect to a center line CL1 in the x-direction.

The non-reciprocal circuit element 105 according to the sixth embodiment has the resonator 55, and therefore has an effect similar to that of the non-reciprocal circuit element 100. The non-reciprocal circuit element 105 according to the sixth embodiment can be applied to a quantum computer, like the non-reciprocal circuit element 100.

### Seventh Embodiment

FIG. 12 is an expanded plan view of a non-reciprocal circuit element 106 according to a seventh embodiment. The non-reciprocal circuit element 106 includes a conductor 10, a first loss layer 21, a second loss layer 22, a first magnet 31, a second magnet 32, a first grounding body 41, a second grounding body 42, and a resonator 56. In the non-reciprocal circuit element 106, constituent elements similar to those in the non-reciprocal circuit element 100 are denoted by similar reference signs and description thereof will be omitted.

The resonator 56 is a meander-line resonator. The meander-line resonator includes a conductor processed into a meander-line shape. By making the conductor meander, a width of the resonator 56 in one direction (for example, the y-direction) can be reduced, and the resonator 56 can be made smaller. A high-frequency signal propagating along a second connection line S2 is trapped by the resonator 56. The resonator 56 is within a range of a high-frequency signal propagating along the second connection line S2. The resonator 56 may or may not be connected to the conductor 10. When the resonator 56 is connected to the conductor 10, the resonator 56 is a quarter-wavelength resonator. When the resonator 56 is separated from the conductor 10, the resonator 56 is a half-wavelength resonator. The resonator 56 is sandwiched between the first absorber 26 and the second absorber 28 in the z-direction. The resonator 56 may be symmetrical or asymmetrical with respect to a center line CL1 in the x-direction.

The non-reciprocal circuit element 106 according to the seventh embodiment has the resonator 56, and therefore has an effect similar to that of the non-reciprocal circuit element 100. The non-reciprocal circuit element 106 according to the seventh embodiment can be applied to a quantum computer, like the non-reciprocal circuit element 100.

### Eighth Embodiment

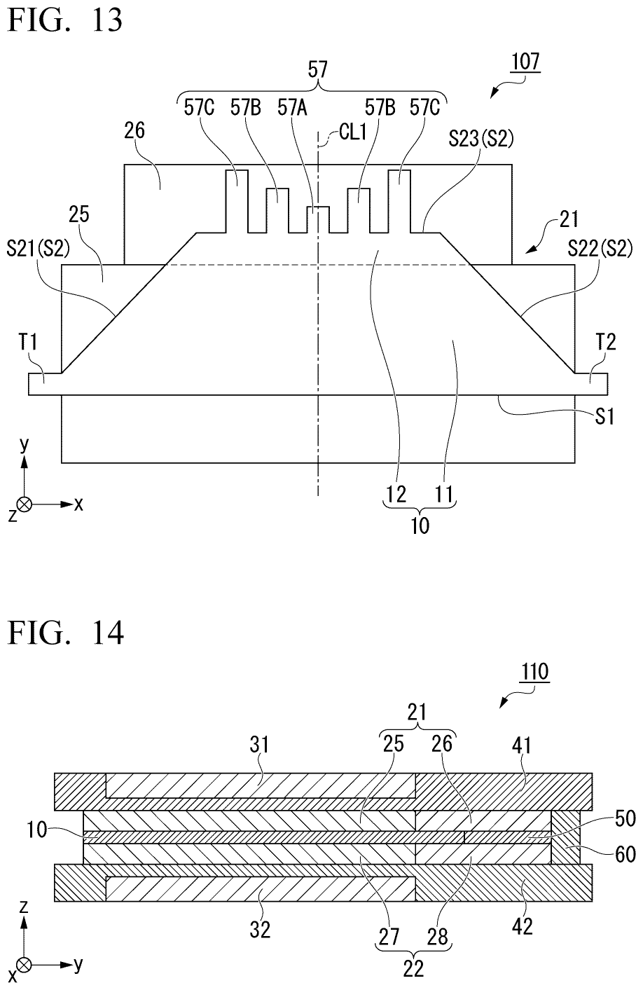

FIG. 13 is an expanded plan view of a non-reciprocal circuit element 107 according to an eighth embodiment. The non-reciprocal circuit element 107 includes a conductor 10, a first loss layer 21, a second loss layer 22, a first magnet 31, a second magnet 32, a first grounding body 41, a second grounding body 42, and a resonator 57. In the non-reciprocal circuit element 107, constituent elements similar to those in the non-reciprocal circuit element 100 are denoted by similar reference signs and description thereof will be omitted.

The resonator 57 includes, for example, a first resonator 57A, a second resonator 57B, and a third resonator 57C. Each of the first resonator 57A, the second resonator 57B, and the third resonator 57C, for example, is connected to the conductor 10. Each of the first resonator 57A, the second resonator 57B, and the third resonator 57C is, for example, a quarter-wavelength resonator.

The first resonator 57A has a first resonant frequency and traps a high-frequency signal of the first resonant frequency among high-frequency signals propagating along a second connection line S2. The second resonator 57B has a second resonant frequency and traps a high-frequency signal of the second resonant frequency among the high-frequency signals propagating along the second connection line S2. The third resonator 57C has a third resonant frequency and traps a high-frequency signal of the third resonant frequency among the high-frequency signals propagating along the second connection line S2. The first resonator 57A, the second resonator 57B, and the third resonator 57C have different lengths in the y-direction, and therefore have different resonant frequencies.

Each of the first resonator 57A, the second resonator 57B, and the third resonator 57C is sandwiched between the first absorber 26 and the second absorber 28 in the z-direction. The first resonator 57A, the second resonator 57B, and the third resonator 57C can use a material similar to that of the conductor 10.

The non-reciprocal circuit element 107 according to the eighth embodiment has the resonator 57, and therefore has an effect similar to that of the non-reciprocal circuit element 100. Moreover, the resonator 57 traps high-frequency signals of a plurality of resonant frequencies, and therefore can improve isolation characteristics in a wide band. The non-reciprocal circuit element 107 according to the eighth embodiment can be applied to a quantum computer, like the non-reciprocal circuit element 100.

The resonator 57 shown in FIG. 13 is an example of a resonator having a different resonant frequency. Resonators having different resonant frequencies are not limited to this example.

For example, the resonant frequency of the resonator is not limited to three wavelength bands, but may be in two wavelength bands, or may be in four or more wavelength bands.

Moreover, for example, the resonator 57 and the conductor 10 may be electrically separated. The resonator 57 electrically separated from the conductor 10 is a half-wavelength resonator. In a plurality of resonators included in the resonator 57, a quarter-wavelength resonator that is in contact with the conductor 10 and a half-wavelength resonator that is not in contact with the conductor 10 may be mixed.

Moreover, some of the resonators constituting the resonator 57 may be ring resonators, spiral resonators, or meander-line resonators. Moreover, all of the resonators constituting the resonator 57 may be ring resonators, spiral resonators, or meander-line resonators.

Although the resonator 57 shown in FIG. 13 is symmetrical with respect to a center line CL1 in the x-direction, the resonator 57 may be asymmetrical with respect to the center line CL1 in the x-direction.

Although several specific examples of the non-reciprocal circuit element have been shown above using a plurality of embodiments, the present disclosure is not limited to these embodiments, and various modifications are possible.

For example, the specific configurations of the non-reciprocal circuit elements according to the first to eighth embodiments may be combined.

Moreover, FIG. 14 is a cross-sectional view of a non-reciprocal circuit element 110 according to a first modified example. Unlike the non-reciprocal circuit element 100 according to the first embodiment, the non-reciprocal circuit element 110 according to the first modified example has a connection part 60. The connection part 60 may be a resistor or a conductor. By providing the connection part 60, the absorption characteristics of high-frequency signals can be further improved. This first modified example can be applied to each of the non-reciprocal circuit elements of the first to eighth embodiments.

### INVENTIVE EXAMPLES

### Inventive Example 1

In Inventive Example 1, a non-reciprocal circuit element 100 having the configuration as shown in FIG. 2 was produced. In a conductor 10 of Inventive Example 1, a resonator 50 having a length L of 1.0 mm is formed on a third side S23 of a second connection line S2. The resonator 50 is symmetrical with respect to a center line CL1 in the x-direction. The resonator 50 is sandwiched between a first absorber 26 and a second absorber 28. Isolation characteristics, reflection loss characteristics, and insertion loss characteristics of the non-reciprocal circuit element of Inventive Example 1 for a frequency were obtained by simulation.

### Inventive Example 2

Inventive Example 2 is different from Inventive Example 1 in that the length L is changed to 1.5 mm. In Inventive Example 2, as in Inventive Example 1, the isolation characteristics, reflection loss characteristics, and insertion loss characteristics of the non-reciprocal circuit element for a frequency were obtained by simulation.

### Comparative Example 1

A non-reciprocal circuit element of Comparative Example 1 was obtained by removing the resonator 50 from Inventive Example 1. In other words, the non-reciprocal circuit element 100 has a configuration similar to that of FIG. 2, but without the resonator 50, and a third side S23 is a straight line. Insertion loss characteristics, reflection loss characteristics, and isolation characteristics of the non-reciprocal circuit element of Comparative Example 1 for a frequency were obtained by simulation.

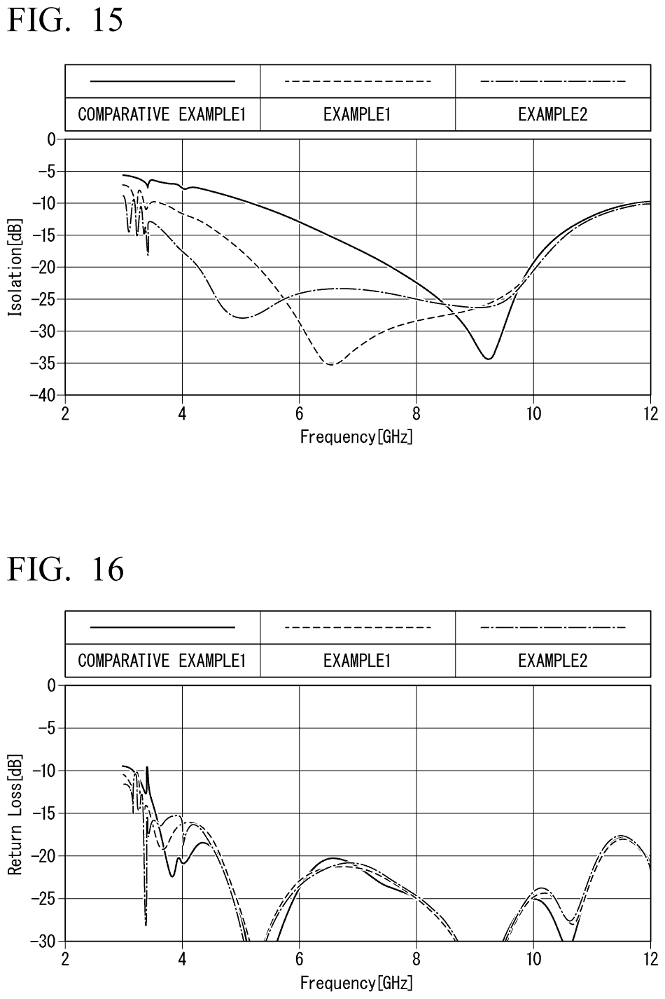

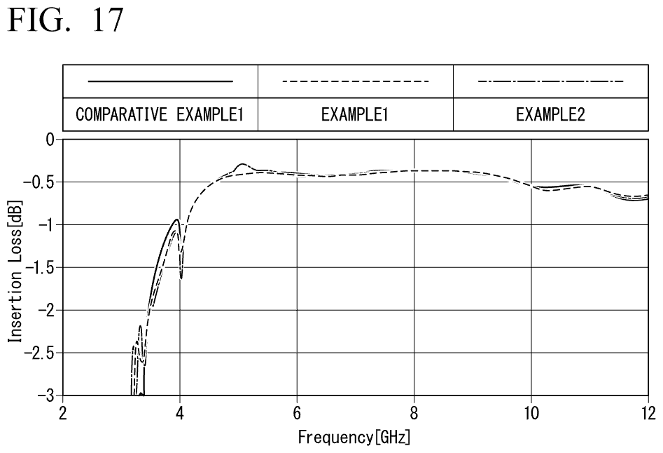

FIG. 15 shows measurement results of isolation characteristics of the non-reciprocal circuit elements according to Inventive Example 1, Inventive Example 2, and Comparative Example 1. FIG. 16 shows measurement results of reflection loss characteristics of the non-reciprocal circuit elements according to Inventive Example 1, Inventive Example 2, and Comparative Example 1. FIG. 17 shows measurement results of insertion loss characteristics of the non-reciprocal circuit elements according to Inventive Example 1, Inventive Example 2, and Comparative Example 1. The horizontal axis in FIGS. 15 to 17 represents a frequency of a high-frequency signal input to a terminal.

As shown in FIG. 15, the isolation characteristics can be improved in a predetermined band by changing the length of the resonator 50. This is thought to be because the resonator 50 traps a part of the high-frequency signal traveling from the second terminal T2 to the first terminal. In other words, by controlling the shape of the resonator 50, it is possible to freely improve the isolation characteristics in a desired band.

In contrast, as shown in FIGS. 16 and 17, there was no significant difference in the insertion loss and reflection loss between Inventive Example 1, Inventive Example 2, and Comparative Example 1. In other words, the resonator 50 had substantially no influence on the insertion loss and reflection loss.

### EXPLANATION OF REFERENCES

10 Conductor
11 First region
12 Second region
21 First loss layer
22 Second loss layer
25 First magnetic body
26 First absorber
27 Second magnetic body
28 Second absorber
31 First magnet
32 Second magnet
41 First grounding body
42 Second grounding body
50, 51, 52, 53, 54, 55, 56, 57 Resonator
57A First resonator
57B Second resonator
57C Third resonator
100, 101, 102, 103, 104, 105, 106, 107, 110, 202, 203 Non-reciprocal circuit element
200 Quantum computer
201 Quantum processor
204, 205 Filter
206 Amplifier
S1 First connection line
S2 Second connection line
S21 First side
S22 Second side
S23 Third side
T1 First terminal
T2 Second terminal

What is claimed is:

1. A non-reciprocal circuit element comprising:
a conductor;
a magnetic body;
an absorber; and
a resonator,
wherein the absorber and the magnetic body are located at different positions when viewed in a thickness direction,
wherein the conductor has a first terminal and a second terminal,
wherein the conductor has a first region extending between the first terminal and the second terminal and a second region different from the first region,
wherein the first region overlaps the magnetic body when viewed in the thickness direction,
wherein the second region overlaps the absorber when viewed in the thickness direction, and
wherein the resonator overlaps the absorber when viewed in the thickness direction.

2. The non-reciprocal circuit element according to claim 1,
wherein the resonator is connected to the conductor.

3. The non-reciprocal circuit element according to claim 1,
wherein the resonator is prevented from being connected to the conductor.

4. The non-reciprocal circuit element according to claim 1,
wherein the resonator is symmetrical with respect to a center line that passes through a center of a straight line connecting the first terminal and the second terminal and is perpendicular to the straight line.

5. The non-reciprocal circuit element according to claim 1,
wherein the resonator is asymmetrical with respect to a center line that passes through a center of a straight line connecting the first terminal and the second terminal and is perpendicular to the straight line.

6. The non-reciprocal circuit element according to claim 1,
wherein the resonator is a quarter-wavelength resonator.

7. The non-reciprocal circuit element according to claim 1,
wherein the resonator is a half-wavelength resonator.

8. The non-reciprocal circuit element according to claim 1,
wherein the resonator is a ring resonator.

9. The non-reciprocal circuit element according to claim 1,
wherein the resonator is a spiral resonator.

10. The non-reciprocal circuit element according to claim 1,
wherein the resonator is a meander-line resonator.

11. The non-reciprocal circuit element according to claim 1,
wherein the resonator includes a first resonator having a first resonant frequency and a second resonator having a second resonant frequency different from the first resonant frequency.

12. The non-reciprocal circuit element according to claim 6,
wherein the quarter-wavelength resonator satisfies a relationship of
$$L \leq 1 / 4 {{f}_{0} ( {ε}_{0} {μ}_{0} {ε}_{γ} {μ}_{γ} )}^{1 / 2} , \qquad ( 1 )$$
where L denotes a length of the quarter-wavelength resonator, f₀ denotes a resonant frequency, ε₀ denotes vacuum permittivity, μ₀ denotes vacuum magnetic permeability, ε_{γ} denotes permittivity of the absorber, and μ_{γ} denotes magnetic permeability of the absorber.

13. The non-reciprocal circuit element according to claim 1,
wherein the resonator is asymmetrical with respect to a center line that passes through a center of a straight line connecting the first terminal and the second terminal and is perpendicular to the straight line, and
wherein the resonator is prevented from being electrically connected to the conductor.

14. A quantum computer comprising the non-reciprocal circuit element according to claim 1.
